(19) United States
(12) Patent Application Publication
(10) Pub. No.: US 2008/0144107 A1
(43) Pub. Date: Jun. 19, 2008

(54) METHOD FOR ARRANGING A COLLECTION OF VISUAL CONTENT

(75) Inventor: Adam Michael Lieb, San Francisco, CA (US)

Correspondence Address: Adam Lieb, 1323 6th Ave., San Francisco, CA, 94122, US

(73) Assignee: INNOVIVE TECHNOLOGIES LLC, San Francisco, CA (US)

(21) Appl. No.: 11/958,394

(22) Filed: Dec. 18, 2007

Related U.S. Application Data
(60) Provisional application No. 60/870,568, filed on Dec. 18, 2006.

(51) Int. Cl. G06F 3/12

(52) U.S. Cl. 358/1.18

(57) ABSTRACT

A method for constructing a collage of visual content, to include images, videos, or application widgets. The content can be comprised of various sizes and aspect ratios. A priority order may be provided. The method will then efficiently arrange the content into a given display area. The display area can be completely covered, such that no content will be cut down or obscured. Content of a higher priority can appear larger, and may also be highlighted through other means.

### CROSS-REFERENCE TO RELATED APPLICATIONS

None.

### FEDERALLY SPONSORED RESEARCH

None.

### SEQUENCE LISTING

None.

### BACKGROUND

1. Field

The method relates to the organization and arrangement of visual content, including images and video. More specifically, the method provides an efficient means to display a set of visual content, consisting of content of various sizes and aspect ratios, within a given space while visually highlighting content of a higher priority.

2. Background

In today's digital age, people are creating more and more images and videos. Inexpensive digital cameras and camcorders and increased storage capacities have led to an explosion in the number of photos and videos that are being recorded or created. In addition, the popularity of user-generated content sharing sites (like Flickr.com and Youtube.com) has encouraged large numbers of people to post their media online for the public to view. Also, as users spend more time online, more advertisers are competing to reach those users, through limited advertising space.

Thus, we live in a world where the amount of visual content available to users (whether it be photos, advertisements, videos, or other types of content) far exceeds the amount of content that can be digested by any single person. There is a new need to prioritize and efficiently display large amounts of visual content to users in a limited space and time.

The simplest methods of arranging visual content in a limited space (i.e. forming a collage) go as far back as the introduction of photography, or even to the original of cave paintings by the earliest humans. The simplest technique of arranging content is to manually position the images in the alloted space. This works, but it has several disadvantages. One disadvantage is that the manual labor required to effectively arrange a collage makes it economically infeasible for many applications, such as pages personalized for each user or a set of ads targeted for each page. Also, when manually arranging content of various sizes and aspect-ratios, manual layouts will use space inefficiently (leaving white space) or force some images be cut down or obscured.

3. Prior Art

Recently, there have been a variety of different approaches designed for fully automated arranging of collage, but all have various restrictions, limitations, or disadvantages. Some techniques are limited to consistently sized images and these are only useful when all images come from the same source and are taken in the same method. These techniques generally focus on how to most appropriately group or cluster images into meaningful sets. Some of these techniques are shown in the following references:

http://research.microsoft.com/˜jplatt/PhotoToC-pacrim.pdf
http://www.cs.umd.edu/hcil/photomesa/
http://iv.slis.indiana.edu/sw/treemap.html
U.S. Pat. No. 7,010,751, Methods for the electronic annotation, retrieval, and use of electronic images, Mar. 7, 2006

Other techniques arrange images with a large amount of wasted space, cut images, or otherwise obscure images. Some algorithms go as far as to try and automatically figure out the best areas in the images to obscure. Some of these techniques are shown in the following references:

http://research.microsoft.com/˜jiansun/papers/PictureCollage_CVPR2006.pdf
http://www.stainedglasscollage.com/
http://picasa.google.com/features/features-create.html

So, while some progress has been made in the field of automated collage arrangement, most of the focus has been on collections of images which share the same size and aspect ratio. This can be a severe limitation when images come from different sources, or even when they come from the same camera. This is because users often take photos in both landscape and portrait mode and digitally crop photos on a computer later. Other techniques also require that significant portions of images be either cut-away or obscured, which is not acceptable for a number of different applications. Ideally, visual content with a variety of sizes and aspect ratios can be arranged into a collage while not cutting or obscuring any content.

Also, existing approaches do not tackle an additional goal, which is to visually demonstrate priority by highlighting some images or video over others. In other words, components of a collage are always regarded as equally important, so it can be useful to visually draw viewers' attention to specific items that are regard as more important.

Thus, there is a need for a new way to efficiently arrange media of various sizes and aspect ratios, and also, optionally visually prioritize media.

### SUMMARY

The method described herein addresses these two goals by providing a means to efficiently arranging a collection of visual content, called “renderings”, into a collage. The renderings can be of various sizes and aspect ratios. By adjusting the display size of each rendering, this method can display a large number of renderings in a relatively small space without cutting, overlapping, or otherwise obscuring any rendering. In addition, it can visually highlight the more important renderings, in order to draw a viewer's attention to content that is of higher importance.

### DRAWINGS

FIG. 1. is an example of a sample rendering set (in this case, an ordered set of images) and the resulting output.

FIG. 2. is an overview flowchart of the steps in the processing of the set.

FIG. 3. demonstrates a rendering that has been positioned in a free space

FIG. 4. shows the example from FIG. 3. after a merge step has completed.

FIG. 5 shows a “tool-tip” expansion window for showing additional information associated with the rendering, where a mouse has hovered over one image in a collage.

FIG. 6. shows a technological summary of a processing device and various output methods for displaying the resulting collage.

### DETAILED DESCRIPTION OF DRAWINGS

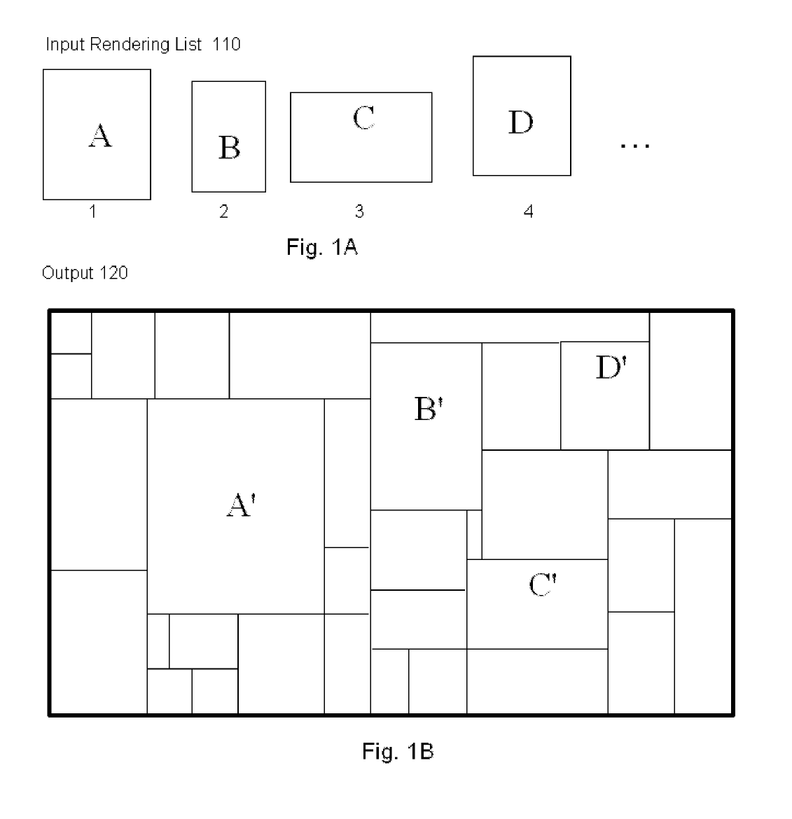

FIG. 1A and FIG. 1B are an example of inputs and outputs for the system. An input 110 is a sorted list of images, or any type of visual content, called “renderings” as described further below. Each rendering is assigned a priority and then sorted accordingly. Although only four source renderings are displayed (A, B, C, and D), the full list could contain hundreds, or thousands, or more. An output 120 shows the collage after all renderings in the group have been positioned (A′, B′, C′, and D′ respectively). All though the sizes of the positioned renderings have changed, the aspect ratios of the positioned renderings match those of the source renderings.

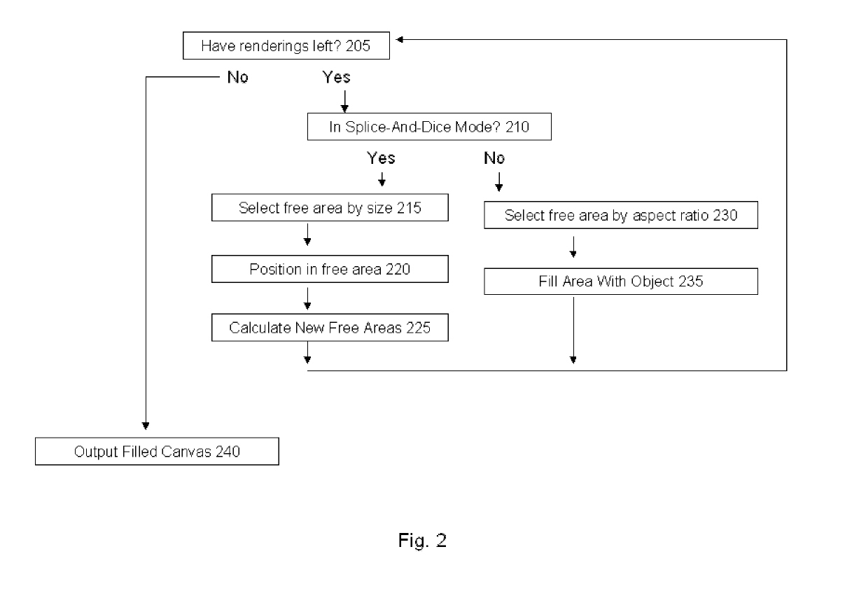

FIG. 2 shows an overview of the steps used to process the renderings of FIG. 1A to the collage of FIG. 1B. First, the system checks if it has renderings remaining to position in the collage. If not, the system outputs the final collage (block 240) and ends. Otherwise, the system checks if it is in splice-and-dice mode, as defined below, or not (block 210). If so, the system selects a free area (block 215), positions the rendering in the free area (block 220), and calculates the new free areas (block 225) from the excess space not used by the rendering. If the system is not in splice and dice mode, the system selects a free area by comparing aspect ratios (block 230) and then completely fills the area with the photographs (block 235), and then repeats (block 205).

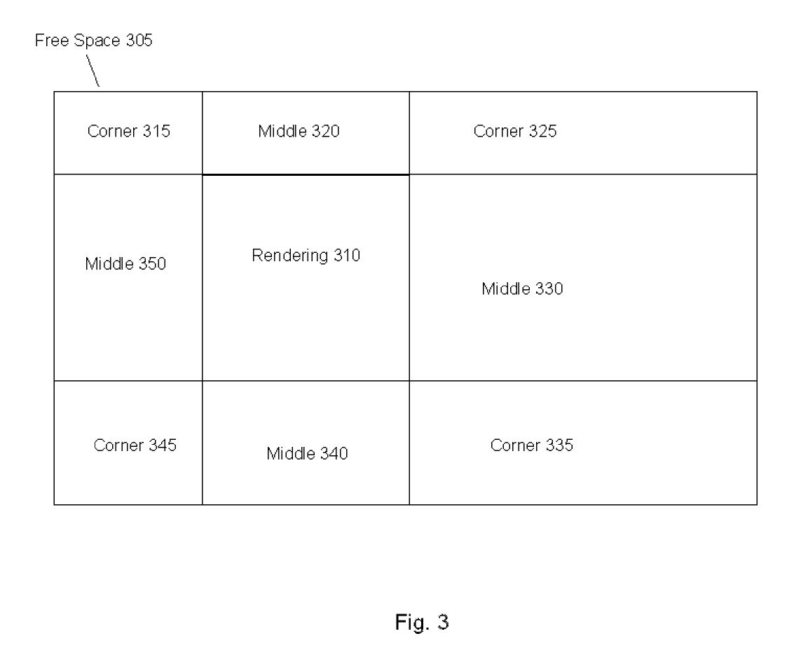

FIG. 3 shows an example of a rendering 310, which has just been positioned in a Free Space 305. The system extends the sides of the rendering until they intersect the sides of the Free Space, thus, in this case, creating four corner areas 315, 325, 335, and 345 and four middle areas 320, 330, 340, and 350.

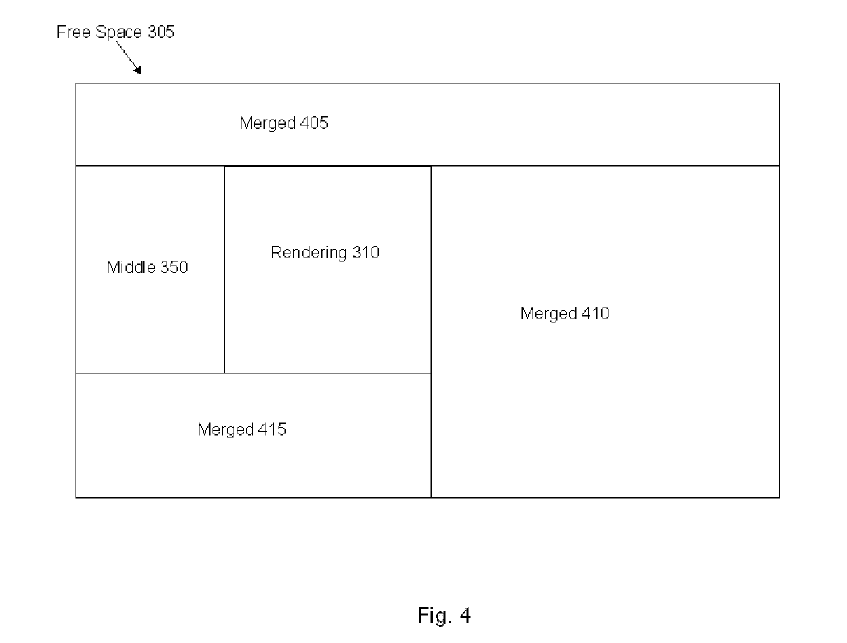

FIG. 4 shows the example from FIG. 3 after the merge step, as explained below, has completed. In this example, corner 315 merged with middle 320 and corner 325 merged with middle 320 to create merged Area 405. Corner 335 merged with middle 330 to create merged area 410. Corner 345 merged with middle 340 to create merged area 415. middle 350 was not merged with any corner. The result was four merged areas from eight pre-merge areas.

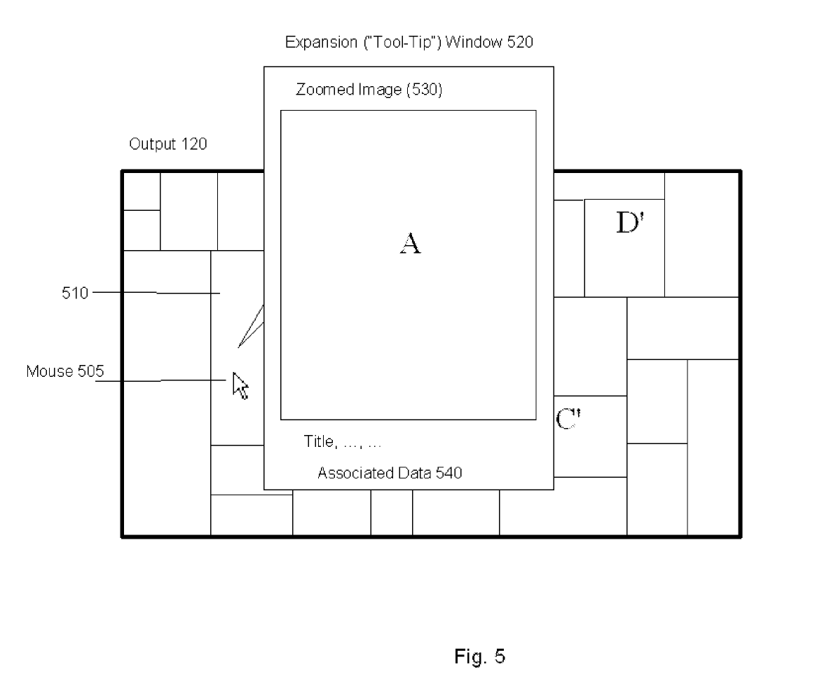

FIG. 5 This demonstrates a “mouse-over” expansion window, otherwise known as a tool-tip, as displayed on a computer monitor. In this example, a mouse cursor 505 is passed over and temporarily hovered above a small image of a “A” 510. The computers user interface responded by displaying a “zoomed-in” window 520, which contains an expanded image of “A” 530, as well as other data 540 associated with the image.

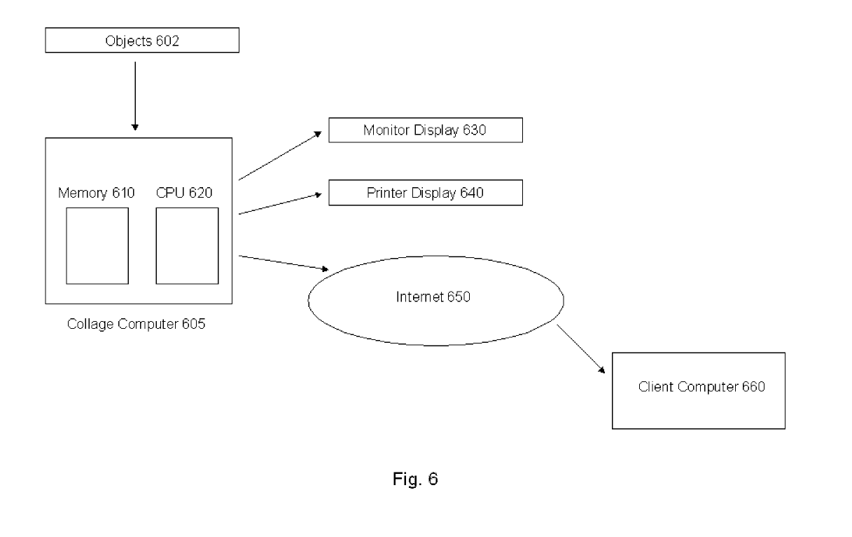

FIG. 6 demonstrates a technology which preferable is used to implement the process. A set of objects 602 is sent to the collage computer 605. The images may exist on the collage computer's hard-drive, or be loaded onto the computer from a removable medium (e.g. a CD, a hard disk, a USB drive, etc) or they can be sent to the computer over a network. Once on the computer, a CPU 620 and memory device 610 complete the arrangement procedure. The resulting output is then sent to either a monitor attached to the computer 630, a psychical printing device attached to the computer 640, or sent over a network to a remote computer, where it is then displayed or printed 660.

### Operation

In the following, I refer to visual media units as renderings. Renderings can be any graphical element that can be displayed within the correct shape, including static images, video feeds, or application widgets, i.e. small units of application software, such as flash presentations, which can contain graphics, text, and user-interface renderings controllable by a user.

### Set of Renderings

The system starts with a collection of renderings. These renderings must all be of the same tileable shape, i.e. shape which can be repetitively tiled, like those on a tiled floor. Normally a tileable shape will be a rectangle, but it can also cover other tileable shapes, e.g. a set of parallelograms which all share equal angles at all four corners.

The renderings in the set can have varying sizes and aspect ratios. In the case of a rectangle, the aspect ratio equals width divided by height.

Also, the renderings in the set do not need to be of the same type of media. For example, some renderings may be images, other may be video feeds, etc.

### Sorting the Renderings

The system can then sort the renderings in to a specific order. The system may do this because renderings ordered first will be displayed at a large size in the final collage. Any criteria associated the renderings and any commonly understood sorting method can be used to sort the renderings. The preferable method is to use insertion sort (described below and at http://en.wikipedia.org/wiki/Sorting_algorithm#Insertion_sort), though other sorting methods can also be used.

For example, the renderings can be photos of members in an online social community, and they can be sorted by some numerical representation of how active or popular each member is within the network.

Or, the renderings can be are advertisements, and they can be sorted according to the revenue potential for each rendering. In the case of web-based advertisements, the revenue potential may be defined as how much an advertiser is willing to display each rendering for the specific web page, web site, and/or user. Or, the revenue potential may be defined as how much an advertiser is willing to pay for a click upon each rendering, multiplied by how likely each rendering has been clicked on in the past.

Or, the renderings may be video feeds from an array of security cameras, and they can be sorted by a “risk-score”, which is calculated by a computer based on the amount of movement in each video at a given time and the position of each camera, and/or other criteria.

The renderings may represent various application widgets. For example, the application widgets may be on a user's online start page, which represents various personalized content like weather, news, alerts, etc. In this example, the widgets can be sorted based on how newsworthy each widget is, e.g. how out-of-normal the weather is, whether there is any breaking news stories, etc.

If the renderings are scientific images or videos recorded by a telescope, microscope, or other imaging device, the computer algorithm can sort the images according to some scientifically relevant criteria, e.g. level of a specific color, types of shape, etc.

If the renderings are a set of video feeds for various channels on a cable network, they can be sorted according to a set of channel or show preferences.

If the renderings are photos of contestants in a contest, such as a modeling or singing contest, they can be sorted according to the current or final standings in the contest.

The renderings do not, however, have to be sorted at all, i.e. they don't have to be in a specific order.

### Canvas

We also need a canvas, which is a memory storage of the visual area in which the renderings will be displayed. In a computer, the memory required for the canvas could be stored in RAM, on a hard-drive, or on any other type storage device attached to the computer. The shape of the canvas must be the same shape as all the renderings, e.g. rectangular, if all renderings are rectangular. Ultimately, the canvas may printed to a digital output, such as a computer monitor, or a physical output, such as a printed poster. As I'll demonstrate, in theory, the system is able to display a mathematically infinite number of images on a given canvas. Though, in practice, the number of displayable renderings is limited by output capabilities of the display and memory and performance limitations of the processing device. For example, a single static image displayed on a computer monitor at a resolution of less then 10 pixels on a side could be nearly invisible to a human viewer. In the printed world, far higher resolutions are possible, including those that can only be read with a microscope or other enlargement device. Therefore, the number of renderings in the set will need to be limited to the display and processing capabilities.

### Set of Free Areas

Next, the system maintains a set of Free Areas, which are distinct areas in the canvas which are empty and available. Each Free Area in the set must be the same shape as all the renderings and the associated canvas, though can be of various aspect ratios. The system initializes this set to contain a single Free Area, the area represented by the entire, empty canvas. The Free Areas are kept in sorted order. The sorting criteria depends on which mode the system is using, as shall be described below.

### Positioning Renderings

Now, the system needs to position all of the renderings on the canvas. The system positions each rendering, one-at-a-time, in sorted order, starting with the first rendering and recursively working through the list to the last rendering. There are two methods used to do this: Splice-And-Dice and Best-Fit. Initially, the system starts in Splice-And-Dice mode.

Splice-And-Dice Mode: Picking a Free Area

First, the system must pick a Free Area within which to position the current rendering. There are two considerations to use when picking a Free Area. One, the system wants to pick a Free Area that has the largest area, since the current rendering is sorted above all the remaining renderings in the set, and should therefore be displayed at a larger size. Second, the system wants to pick a free space that has an aspect ratio as close as possible to the aspect ratio of the rendering, since this will allow the system to most effectively use the space in the Free Area for displaying the rendering, and will result in more usable Free Spaces once the system positions the rendering in this free space, and then splits up the leftover space in to additional free spaces.

During Splice-And-Dice mode, the system keeps the set of Free Areas sorted according to area-size, since the area consideration is more important.

The system examines the top X free areas, in terms of size, and pick the free area with the aspect ratio closest to the rendering. X may equal 1 (so that the system only takes size into account), or may be set above one (like 3), so that the system can also, in part, consider the aspect ratio.

### Splice-And-Dice Mode: Positioning the Rendering

Now that the system has selected a Free Area, the system needs to position the rendering within the area. There are two things to consider when positioning the rendering. One is the display size at which the system will scale the rendering to, and the x,y coordinates of the rendering's location within the Free Area.

The system will limit the display size of the rendering, so that the rendering's width does not exceed some fraction of the Free Space's width, and the rendering's height does not exceed some fraction of the Free Area's height, while insuring the aspect ratio of the display area matches the aspect ratio of the rendering. These fractional limits may be static for all renderings, or may be dynamic for each rendering. For example, the renderings earlier in the list, which may have a higher priority, can take up a higher fraction of the Free Area.

For the x,y coordinates of the rendering within the Free Area, the system can choose from several different approaches. One method is to always position the rendering in a specific location. For example, the system can always center the rendering within the Free Area, or always position it in the top left corner, or position in a specific sequence of locations (e.g. first rendering is in the top left corner, then top center, then top right, then right center, etc.) Alternatively, the system can randomly position the rendering within the Free Area, at a random x,y coordinate, such that the rendering is wholly within the Free Area. The system can use a technique called “Random-And-Snap” m in which the rendering is randomly positioned, and then “snapped-to” one or more boundaries of the Free Area if the distance between the boundary and the rendering is less then some specific fraction of the Free Area's width or height, as appropriate. This snap helps to insure that there are fewer very thin or very tall Free Areas created during the splice step. It is also possible to combine these approaches in various ways. For example, the system might always center the first rendering, then use Random-And-Snap for the rest. Normally, the operator of the system will choose which method or methods will be used.

All these technique variations will impact the overall visual effect (including the distribution and placement consistency) once all renderings are laid out.

### Splice-and-Dice Mode: Splicing More Free Areas

Now, the system must create more Free Areas from the excess of the current Free Areas space not occupied by the current rendering. The system does this by drawing lines extending the boundaries of the rendering until they meet the boundaries of the Free Area. This will create up to eight distinct areas, represented by up to four corner areas and four middle areas (FIG. 3), though there can be less if the rendering and Free Area share one or two boundaries. The system could simply add these areas to list of Free Areas, but may often prefer to combine these areas first to create larger areas to work with for future renderings. We can do this by randomly merging each corner area with one of the adjacent middle areas. This will create between two and four larger areas (depending on how many boundaries the rendering and Free Area share).

There are some special cases to this procedure. In case the Free Areas aspect ratio exceeds some maximum (too wide), the system can remove the randomness in the merge decision by disallowing the option to merge two areas which are adjacent horizontally, and instead always merge corners with middles that are either directly above or below vertically. Likewise, in case the Free Area's aspect ratio is less then some minimum (too tall), the system can force the corners to merge only with those areas to the left or right. This special case avoids a “spaghetti problem” where many Free Spaces become so extremely wide or tall that they are unusable.

Also, in the event that the Number of Renderings Left to be positioned minus the Number of Open Spaces is less then 9, the system will bypass some or all of the corner merges (and also bypass the Snap step of the Random-And-Snap procedure). This insures that the Number of Renderings Left to be positioned and the Number of Open Spaces will be exactly equal after this rendering's turn.

Once the new Free Spaces are determined, they are added to the Free Space set using a Sorted Insert step as described below (and the outer Free Space is removed).

### Changing Modes

In the event that the Number of Renderings Left to be positioned equals (or if, for some reason, is less than) the Number of Open Spaces, the system switches from Splice-And-Dice mode to Best-Fit mode. Also, the system re-order the Free Spaces according to aspect ratio (instead of by size) by re-running the sort operation with a new sorting criteria.

### Best-Fit Mode

At this point, the system now has all the Free Areas it needs in order to position the rest of the renderings. The system now has a large number of small areas to work with so, the system shifts the focus from finding the biggest area to work with, to finding the Free Area with the closest aspect ratio. The system does this by using a Quick Search procedure (as described below) to quickly find the Free Area that most closely matches the aspect ratio of the rendering. Then, the system simply positions the rendering to fully fill the Free Space. The aspect ratio may not match exactly, but normally the difference is so small (and the overall size so small) that this difference is imperceptible to a viewer.

### Sorted Insert and Tree Search

The above method refers to a sorted insert technique used when inserting new Free Areas into a sorted list. This is generally known, common algorithmic method. One way to implement this method is to record two positions, a start index and end index in the list. The mid-point is calculated from the start and end. Then, the rendering to be inserted is compared to the rendering at this mid-point. If it is less then this rendering, the mid-point becomes the end-point, otherwise, the mid-point becomes the start-index. This process is repeated recursively until the start equals the end index, which signifies the point at which the new rendering should be inserted. The tree search algorithm is very similar, only the system is only looking for an rendering in a sorted list which best matches a given value, instead of looking for an insertion point.

### Output

Assuming that the switch between the Splice-and-Dice and Best-Fit modes is made at the correct time per above, then the last rendering in the set will be placed into the last Free Area and, the canvas will be completely covered. When the renderings are painted into their assigned display areas, the system can optionally leave a border (one or more pixels of whitespace—for example, surrounding the right and bottom sides of each rendering) to better visually separate the renderings. The canvas is then outputted using the display device.

In the case of outputting to an interactive device, such as a computer monitor, the system can provide additional functionality to make viewing all the renderings easier. For example, the system can provide a “tool-tip”, which is a secondary informational window that is displayed when a user's mouse passes or hovers over any particular rendering. This secondary window can include a zoom-in view of each rendering (to make it easier to view the renderings displayed at a small size), as well as other data which may be associated with each rendering.

In the event the system is dealing with dynamic data, where the set of renderings and/or sort order can change over time (for example, video feeds from security cameras) it will be necessary to update the display. The simplest way to do this is to simply re-run the entire layout procedure. In this case, it is better to use the non-randomized alternatives listed above, so that the overall layout will be more or less the same after minor variations in the renderings. A more advanced alternative is to re-layout only a subset of the renderings. In this case, the system must first identify a canvas subset which contains all the renderings which must change. Given the recursive nature of the splice-and-dice method, it's likely that the system will be able to easily identify a canvas subset which contains all the renderings in question, assuming a small number of renderings have changed.

Thus far, the process has exclusively used size to differentiate important renderings from less important renderings. However, other methods, in addition to size, can be used to further highlight important renderings. For example, more important renderings can be displayed with increased levels of color saturation, and less important renderings could have less color/more-greyscale. Or, more important renderings could have colored borders, highlighted color overlays, or blinking effects or other animations.

### CONCLUSION

In conclusion, the method described above can arrange a collage from a set of renderings. This method can quickly and efficiently display a large number of renderings of various sizes and aspect ratios. No rendering is cut or otherwise obscured, and a large number of renderings can be packed into a relatively small space. In addition, this method can visually highlight the more important renderings in order to draw a viewer's attention to content that is of higher importance.

Although the description above contains many specifics, these should not be construed as limiting the scope of the method but merely providing illustrations of some of the presently preferred embodiments of this method. Thus the scope of the method should be determined by the appended claims and their legal equivalents, rather than by the examples given.

1. A method, comprising:
receiving a set of two dimensional, tileable, graphical renderings and a display area, and
arranging said renderings within said display area by adjusting the display sizes of said renderings so that said renderings fit within said display area.

2. The method of claim 1, wherein said renderings are shaped as rectangles.

3. The method of claim 1, wherein said renderings are comprised of photographs.

4. The method of claim 1, wherein said renderings are comprised of advertisements.

5. The method of claim 1, wherein said renderings are comprised of videos.

6. The method of claim 1, wherein said renderings are comprised of software applications.

7. The method of claim 1, wherein each rendering, when arranged in said display area, is fully visible and is not otherwise clipped, obscured, or overlapped with other renderings.

8. The method of claim 1, wherein some of said renderings are removed from said set and then the remaining renderings in said set are arranged within said display area.

9. The method of claim 1, wherein said renderings are arranged in said display area to completely cover said display area.

10. The method of claim 1, wherein each rendering is assigned a priority score according to information associated with each rendering.

11. The method of claim 10, wherein said priority score depends on a monetary value assigned to the rendering.

12. The method of claim 10, wherein said priority score depends on how closely the attributes assigned to the rendering matches a particular search criteria.

13. The method of claim 10, wherein renderings with better priority scores are displayed at larger sizes than renderings with lesser priority scores.

14. The method of claim 10, wherein renderings with better priority scores are displayed with more colors or brighter colors than renderings with lesser priority scores.

15. A system, comprising:
a processor;
a memory coupled to said processor;
a user interface coupled to said processor;
said memory and processor being arranged to
(a) receive a set of two dimensional, tileable, graphical renderings,
(b) arrange said renderings within a display area, by adjusting the display sizes of said renderings as necessary to fit said renderings within said display area and to position some of said renderings at a larger size then other of said renderings.
(c) display said display area to the user interface.

16. The system of claim 15, wherein the user interface is a computer monitor.

17. The system of claim 15, wherein the user interface is a printer.
